(19) United States
(12) Patent Application Publication
(10) Pub. No.: US 2011/0134115 A1
(43) Pub. Date: Jun. 9, 2011

(54) DISPLAY DEVICE, LIQUID CRYSTAL SHUTTER GLASSES AND DISPLAY SYSTEM USING THE SAME

(75) Inventors: Shigesumi Araki, Ishikawa-ken (JP); Kazuhiro Nishiyama, Ishikawa-ken (JP); Kenji Nakao, Ishikawa-ken (JP); Tetsuo Fukami, Ishikawa-ken (JP); Toshiyuki Higano, Ishikawa-ken (JP); Daiichi Suzuki, Ishikawa-ken (JP); Emi Higano, Ishikawa-ken (JP)

(73) Assignee: Toshiba Mobile Display Co., Ltd., Fukaya-shi (JP)

(21) Appl. No.: 12/958,759

(22) Filed: Dec. 2, 2010

(30) Foreign Application Priority Data
Dec. 7, 2009 (JP) 2009-277826

(51) Int. Cl. G06T 15/00

(52) U.S. Cl. 345/419

(57) ABSTRACT

In one embodiment, a display device includes a display panel having pixels. A first image signal for displaying two-dimensional pictures, a second image signal for displaying three-dimensional pictures, and a third image signal for displaying a black picture are written into the pixels. A control circuit writes the third image signal to the pixel of the display panel during at least one frame period when switching a first mode for displaying the two-dimensional pictures and a second mode for displaying the three-dimensional pictures.

### CROSS-REFERENCE TO RELATED APPLICATION

This application is based upon and claims the benefit of priority from prior Japanese Patent Application No. 2009-277826, filed Dec. 7, 2009, the entire contents of which are incorporated herein by reference.

### FIELD

The present invention relates to a display device, a pair of liquid crystal shutter glasses and a display system for 3D display.

### BACKGROUND

In recent years, a 3D (three-dimensional) display enters in a market, and also extends to household electronic appliances. In the household electronic appliances, it is rare for 3D display system to be used exclusively for 3D display. Accordingly, a function to switch back and forth between 3D display mode and 2D (two-dimensional) display mode is called for the household electronic appliances.

For example, Japanese Laid Open Patent Application No. 2004-163447 discloses an electronic device having a display which can selectively switch back and forth between the 2D image and the 3D image. The electronic device is equipped with a display function which switches the 3D image display to the 2D image display by compulsion while the 3D image is displayed.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a figure showing a display system according to one embodiment of the present invention constituted so that the display mode can be switched between a first mode that displays the two-dimensional (2D) pictures and a second mode that displays the three-dimensional (3D) pictures.

FIG. 2 is a cross-sectional view schematically showing a liquid crystal panel LQP applied to a pair of shutter glasses shown in FIG. 1.

FIG. 3 to FIG. 8 are figures for respectively explaining the operation of first to sixth embodiments.

### DETAILED DESCRIPTION OF THE INVENTION

A display device, a pair of liquid crystal shutter glasses and a display system according to an exemplary embodiment of the present invention will now be described with reference to the accompanying drawings wherein the same or like reference numerals designate the same or corresponding parts throughout the several views.

According to one embodiment, a display device includes: a display panel including pixels, a first image signal for displaying two dimensional pictures, a second image signal for displaying three dimensional pictures, and a third image signal for displaying a black picture being written into the pixels; and a control circuit to write the third image signal to the pixels of the display panel during at least one frame period when switching a first mode for displaying the two dimensional pictures and a second mode for displaying the three dimensional pictures.

According to other embodiment, a display device includes: a transmissive type display panel including pixels, a first image signal for displaying two dimensional pictures and a second image signal for displaying three dimensional pictures being written into the pixels; a back light to illuminate the display panel; and a control circuit to switch off the back light during at least one frame period when switching a first mode for displaying the two dimensional pictures and a second mode for displaying the three dimensional pictures.

According to other embodiment, a display device includes: a display panel including pixels, a first image signal for displaying two dimensional pictures and a second image signal for displaying three dimensional picture, and a control circuit to change gradually the luminance of the display panel over two or more frame periods when switching a first mode for displaying the two dimensional pictures and a second mode for displaying the three dimensional picture.

According to other embodiment, a pair of liquid crystal shutter glasses includes: a first liquid crystal shutter arranged at a right eye side; a second liquid crystal shutter arranged at a left eye side; and a control circuit to control the transmissivity of the first and second liquid crystal shutters; wherein in a first mode for displaying two dimensional pictures, the transmissivity of the first liquid crystal shutter and the second liquid crystal shutter are controlled to a first transmissivity; in a second mode for displaying three dimensional pictures, when a picture for the right eye is observed, the first liquid crystal shutter is controlled to a second transmissivity higher than the first transmissivity, and the second liquid crystal shutter is closed; and in the second mode for displaying the three dimensional pictures, when a picture for the left eye is observed, the second liquid crystal shutter is controlled to a second transmissivity higher than the first transmissivity, and the first liquid crystal shutter is closed.

According to other embodiment, a display system includes: a display panel including pixels, a first image signal for displaying two dimensional pictures and a second image signal for displaying three dimensional pictures for right eye and left eye being written into the pixels; a pair of liquid crystal shutter glasses including a first liquid crystal shutter arranged at the right eye side and a second liquid crystal shutter arranged at the left eye side; and a control circuit to control the transmissivity of the first and second liquid crystal shutters; wherein in a first mode for displaying the two dimensional pictures, the transmissivity of the first liquid crystal shutter and the second liquid crystal shutter is controlled to the a transmissivity while the first image signal is written in the pixels; in a second mode for displaying the three dimensional pictures, when a picture for the right eye is observed, the first liquid crystal shutter is controlled to a second transmissivity higher than the first transmissivity, and the second liquid crystal shutter is closed in synchronization of writing of the picture signal for the right eye to the pixel; and when a picture for the left eye is observed, the second liquid crystal shutter is controlled to a second transmissivity, and the first liquid crystal shutter is closed in synchronization of writing of the picture signal for the left eye to the pixel while the second image signal is written in the pixels.

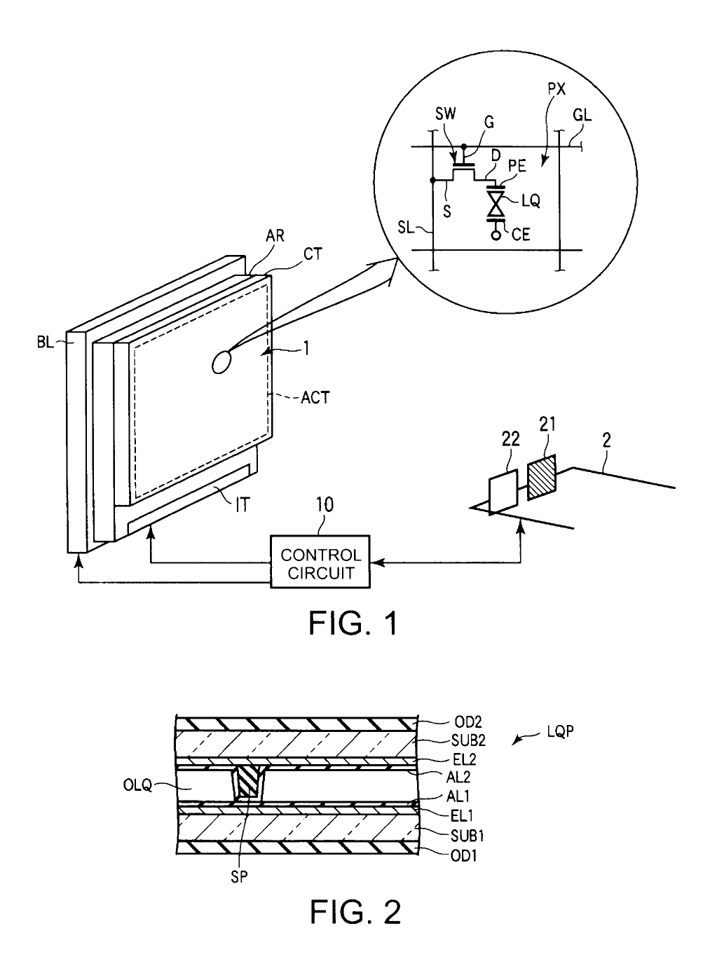

FIG. 1 is a figure showing a display system according to one embodiment constituted so that the display mode can be switched between the first mode for displaying the two dimensional (2D) pictures and the second mode that displays the three dimensional (3D) pictures.

The display system includes a display panel 1, a pair of liquid crystal shutter glasses 2 equipped with optical shutters in both right eye and left eye sides, and a control circuit 10, etc. The display panel 1 and the shutter glasses 2 are connected to the control circuit 10. The display panel 1 is equipped with an input terminal IT into which a driving signal outputted from the control circuit 10 is inputted. Here, the electrical connection between the shutter glasses 2 and the control circuit 10 may be made by wireless or lines.

In this embodiment, the display panel 1 is formed of, for example, a transmissive type liquid crystal display panel. The structure of the display panel 1 is explained in brief. The display panel 1 is constituted by holding a liquid crystal layer LQ between an array substrate AR and a counter substrate CT and includes an active area ACT in which the pictures are displayed. The active area ACT is constituted by a plurality of pixels PX arranged in the shape of a matrix.

Gate lines GL and source lines SL are formed in the active area ACT. A switching element SW is formed in each pixel PX. The switching element SW is constituted by, for example, a thin film transistor. A gate electrode G of the switching element SW is electrically connected to the gate line GL. A source electrode S of the switching element SW is electrically connected to the source line SL. A drain electrode D of the switching element SW is electrically connected to a picture electrode PE arranged in each pixel PX. A counter electrode CE is arranged opposing to the picture electrode PE so as to hold the liquid crystal layer LQ between both electrodes.

Moreover, the display system includes a backlight BL which illuminates the display panel 1. The backlight BL is arranged at the back side of the array substrate AR of the display panel 1. Various types of backlights can be used, for example, the back lights using a light emitting diode or a cold cathode fluorescent lamp as a light source. The explanation is omitted about a detailed structure of the backlight.

The shutter glasses 2 includes a first liquid crystal shutter 21 for the right eye side and a second liquid crystal shutter 22 for the left eye side. The fundamental structure of the first liquid crystal shutter 21 and the second liquid crystal shutter 22 is the same. The detailed structure is mentioned later.

Some signals are supplied to the control circuit 10. They are image data for displaying the two-dimensional pictures or the three-dimensional pictures, a switch signal required for switching the display mode between the first mode for displaying the two-dimensional pictures and the second mode for displaying the three-dimensional pictures, and a synchronizing signal etc. The control circuit 10 outputs a driving signal etc. required for displaying the two-dimensional pictures or the three-dimensional pictures on the display panel 1. Moreover, the control circuit 10 outputs a driving signal etc. which controls lighting and putting out of light to the backlight BL. Moreover, the control circuit 10 outputs a driving signal etc. to the shutter glasses 2 to control “opening” and “closing” of the first liquid crystal shutter 21 and the second liquid crystal shutter 22.

In the combination of the display panel 1 and the backlight BL, while displaying the pictures corresponding to the image data based on the driving signal (image signal is included) supplied from the control circuit 10, it is also possible to display a black picture.

For example, when the display panel 1 is a normally black mode, the black picture is displayed by supplying the driving signal which makes a potential difference between the picture electrode PE and the counter electrode CE zero or comparatively small. Moreover, when the display panel 1 is a normally white mode, the black picture is displayed by supplying the driving signal with a comparatively high potential difference between the picture electrode PE and the counter electrode CE.

On the other hand, in the backlight BL usually turned on while displaying the picture on the display panel 1, a display state substantially equivalent to the black display is formed by putting out the light during at least one frame period irrespective of the operation of the display panel 1.

FIG. 2 is a cross-sectional view of the liquid crystal panel LQP applied to the first liquid crystal shutter 21 and the second liquid crystal shutter 22 of the shutter glasses 2.

The liquid crystal panel LQP includes a first electrode EL1 arranged on the first insulating substrate SUB1, a second electrode EL2 arranged on the second insulating substrate SUB2, and an OCB (Optically Compensated Bend) type liquid crystal layer OLQ etc. held between the first electrode EL1 and the second electrode EL2. For example, pillar shaped spacers SP are provided between the first electrode EL1 and the second electrode EL2, and the gap for holding the liquid crystal layer OLQ is secured.

The first insulating substrate SUB1 and the second insulating substrate SUB2 are formed of a glass substrate or a plastic substrate which shows light transmissive characteristics. The first electrode EL1 and the second electrode EL2 are formed of electric conductive materials which have light transmissive characteristics such as Indium Tin Oxide (ITO) and Indium Zinc Oxide (IZO). The first electrode EL1 is formed substantially all over the inside surface of the first insulating substrate SUB1. Similarly, the second electrode EL2 is formed all over the inside surface of the second insulating substrate SUB2 so as to oppose to the first electrode EL1. The respective first electrode EL1 and second electrode EL2 are connected to a voltage source.

A first alignment film is arranged between the liquid crystal layer OLQ and the first electrode EL1, and similarly a second alignment film AL2 is arranged between the liquid crystal layer OLQ and the second electrode EL2. The pillar shaped spacers SP are arranged on the second electrode EL2 and extend toward the first electrode EL1. The pillar shaped spacers SP are covered with the alignment film AL2. The rubbing direction of the first and second alignment films AL1 and AL2 is the same.

A first optical element OD1 is arranged on the external surface of the first insulating substrate SUB1. Moreover, a second optical element OD2 is arranged on the external surface of the second insulating substrate SUB2. Both the first optical element OD1 and second optical element OD2 include a polarizing plate and a retardation film, respectively.

In the liquid crystal panel LQP of such structure, the liquid crystal molecules contained in the liquid crystal layer OLQ are set in a splay alignment state when a potential difference is not formed between the first electrode EL1 and the second electrode EL2.

If a power is supplied to the liquid crystal panel LQP and a voltage more than a threshold voltage is impressed between the first electrode EL1 and the second electrode EL2, the liquid crystal molecules contained in the liquid crystal layer OLQ are transferred from the splay alignment state to a bend alignment state. In the state of the bend alignment, if a first voltage of substantially zero is applied to the liquid crystal layer OLQ, the liquid crystal panel LQP becomes in the state which can pass light. That is, the first liquid crystal shutter 21 and the second liquid crystal shutter 22 become the state respectively corresponding to the “opening” state.

On the other hand, in the case a second potential difference, which is larger than the first potential difference, is formed between the first electrode EL1 and second electrode EL2, most of the liquid crystal molecules contained in the liquid crystal layer OLQ are aligned in a direction of electrical field. At this time, the liquid crystal panel LQP is in the state where the light hardly passes, and the first liquid crystal shutter 21 and the second liquid crystal shutter 22 are a state respectively corresponding to “closing” state.

In addition, when a third potential difference which is larger than the first potential difference and smaller than the second potential difference is impressed between the first electrode EL1 and second electrode EL2, an intermediate transmissivity is obtained corresponding to what is called gray level in a liquid crystal display panel, if the transmissivity of the liquid crystal panel LQP in the state where the first potential difference is formed is made into 100%, and the transmissivity of the liquid crystal panel LQP in the state where the second potential difference is formed is made into 0%.

Next, the operation in the first mode in the display system according to this embodiment is explained in brief.

The display panel 1 displays a picture during one frame period based on the driving signal supplied from the control circuit 10. In the first mode, the frame frequency for writing the image signal for one frame in the pixels PX is, for example, 60 Hz.

The two-dimensional pictures displayed on the display panel 1 can be observed in the first mode without using the shutter glasses 2. However, even if it is a case where the display panel 1 is observed through the shutter glasses 2, the two-dimensional pictures of the display panel 1 can be observed because the first liquid crystal shutter 21 and the second liquid crystal shutter 22 are always open.

Next, an operation in the second mode is explained in brief. The display panel 1 displays alternately the picture for the right eye and the picture for left eye. In the second mode, the frame frequency for writing the image data for the right eye and the left eye is respectively 120 Hz and is twice as high as the frame frequency in the first mode.

In the second mode, the first liquid crystal shutter 21 and the second liquid crystal shutter 22 of the shutter glasses 2 are switched in synchronization with the pictures displayed on the display panel 1. That is, when the picture for the right eye is displayed on the display panel 1, the first liquid crystal shutter 21 opens, while the second liquid crystal shutter 22 closes. On the other hand, when the picture for the left eye is displayed on the display panel 1, the second liquid crystal shutter 22 opens, while the first liquid crystal shutter 21 closes. Thereby, it becomes possible to observe the three-dimensional pictures according to right-and-left parallax difference.

In this display system, although the case where the three-dimensional pictures can be observed through the shutter glasses 2 is explained in the second mode, if a directional backlight which distributes the emitted light to the user's right and left eyes position is used as the backlight BL combined with the display panel 1, the three-dimensional pictures can be observed without using the shutter glasses, and thereby the shutter glasses become unnecessary.

In the display system mentioned above, since the frame frequency changes when the first mode and the second mode are switched, it is difficult to switch the display smoothly. Since the frame frequency is doubled from 60 Hz to 120 Hz specifically when the switch signal to switch the mode from the first mode to the second mode is received in the control circuit 10, the display panel 1 has a high possibility that a normal display cannot be performed during at least one or more frames, that is, the picture is disturbed when changing the frame frequency.

Moreover, it is necessary to operate the shutter glasses 2 in synchronization with the timing when the pictures for the right eye and the left eye are alternately displayed on the display panel 1 in the display system which observes the three-dimensional pictures in the second mode using the shutter glasses 2. At the changing timing of the synchronization immediately after the first mode and the second mode are switched, the signal required for the synchronization may stop. Therefore, the user can not observe the normal picture while there is a possibility of giving a discomfort feeling to the user.

Then, in this embodiment, when the switch signal which switches the first mode and the second mode is received in the control circuit 10, the black picture is certainly displayed during at least one or more frames. Hereinafter, the practical method to display the black picture is explained.

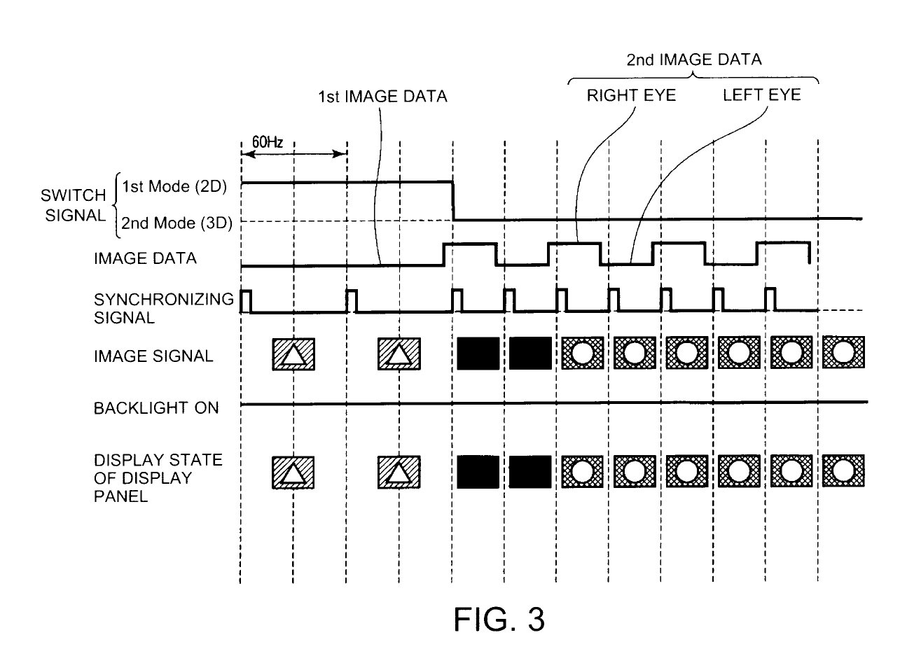

FIG. 3 is a figure for explaining a first embodiment for displaying the black picture on the display panel 1.

FIG. 3 shows the switch signal supplied to the control circuit 10, the image data, the synchronization signal, the picture signal supplied to the display panel 1 from the control circuit 10, the driving signal supplied to the backlight BL from the control circuit 10, and the display state on the display panel 1. The image data includes a first image data for displaying the two-dimensional pictures and a second image data for displaying the three-dimensional pictures containing the image data for the right eye and the left eye.

While the first mode is selected, the image signal is written in each pixel PX of the display panel 1 in the frame frequency of 60 Hz based on the first image data supplied to the control circuit 10. While the second mode is selected, the image signal for the right eye and the left eye are written in each pixel PX of the display panel 1 by turns in the frame frequency of 120 Hz based on the second image data supplied to the control circuit 10. While writing the image signals to the pixels PX, the backlight BL is turned on.

When switching the first mode and the second mode by the switch signal, the control circuit 10 supplies the image signal to each pixel PX of the display panel 1 for displaying the black picture during at least one frame period irrespective of the supplied image data. For this reason, the display state in the display panel 1 becomes in a black display state. In this embodiment shown in FIG. 3, the black display state is continuing over two-frame period.

In addition, although, in FIG. 3, the operation at the time of switching from the first mode to the second mode is explained, the same method can be applied also when switching from the second mode to the first mode.

According to this embodiment using such method, when switching the first mode and the second mode, the fault of the display is not observed by the user, and it becomes possible to reduce the user's discomfort feeling.

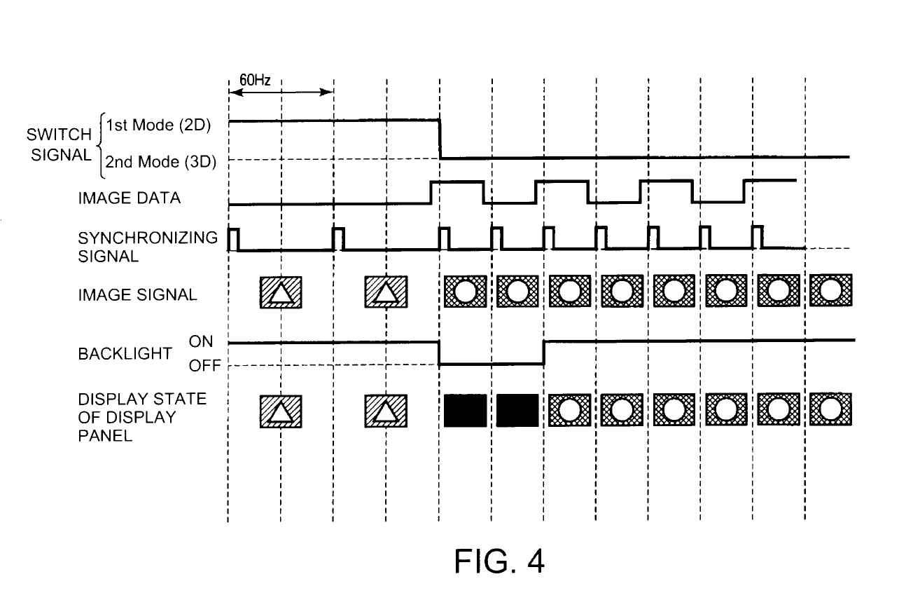

FIG. 4 is a figure for explaining the operation of a second embodiment for displaying the black picture on the display panel 1. FIG. 4 shows the switch signal supplied to the control circuit 10, the image data, the synchronizing signal, the picture signal supplied to the display panel 1 from the control circuit 10, the driving signal supplied to the backlight BL from the control circuit 10, and the display state on the display panel 1 like FIG. 3.

In the embodiment shown in FIG. 4, when switching the first mode and the second mode by the switch signal, the control circuit 10 supplies a driving signal to the backlight BL to switch off the backlight BL during at least one-frame period irrespective of the supplied image data. For this reason, the display state on the display panel 1 becomes the black display state. In this embodiment, the black display state is continuing over two-frame period.

In FIG. 4, although the operation at the time of switching from the first mode to the second mode is explained, the same method can be applied also when switching from the second mode to the first mode. Also in this embodiment, the same effect as the embodiment explained in FIG. 3 is obtained.

By the way, when the two-dimensional pictures are displayed in the first mode, the two-dimensional pictures displayed during one frame period are observed by both eyes. In contrast, when the three-dimensional picture is displayed in the second mode, the displayed picture for the right eye is observed only by the right eye, and the picture for the left eye is observed only by the left eye during a ½ frame period of displaying the two-dimensional picture.

For this reason, when the first mode and the second mode are switched, there is a possibility of giving the user the discomfort feeling due to an abrupt change of luminosity. For example, the user feels that luminosity falls abruptly when the mode switches from the first mode to the second mode, and when the mode switches from the second mode to the first mode, the user feels that the luminosity rises abruptly.

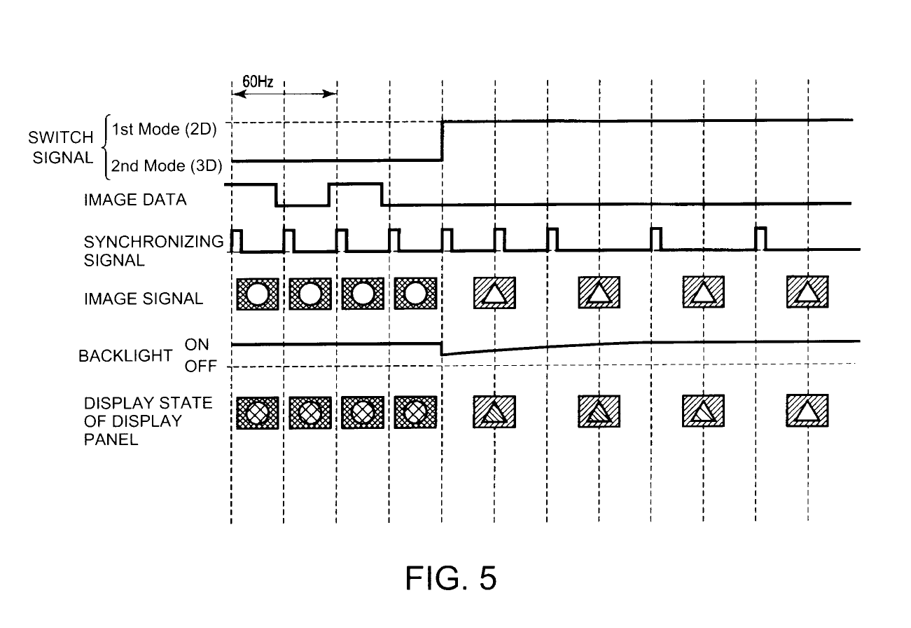

FIG. 5 is a figure for explaining a third embodiment for changing the luminosity of the display panel 1 gradually. Then, in this embodiment, when the switch signal which switches the first mode and the second mode is received in the control circuit 10, the luminosity of the display panel 1 is gradually changed over two or more frame periods. Hereinafter, the practical method is explained.

FIG. 5 shows the switch signal supplied to the control circuit 10, the image data, the synchronizing signal, the picture signal supplied to the display panel 1 from the control circuit 10, the driving signal supplied to the backlight BL from the control circuit 10, and the display state in the display panel 1 like FIG. 3.

In the embodiment shown in FIG. 5, when switching the first mode and the second mode by the switch signal, the control circuit 10 supplies the driving signal to the backlight BL to change the luminosity over two or more frame period irrespective of the supplied image data. Here, the operation to switch from the second mode to the first mode is illustrated, and in this case, the luminosity of the backlight BL changes so that the luminosity may go up gradually.

If the luminosity of the backlight BL in the second mode is made into 100%, the control circuit 10 changes the luminosity of the backlight BL as follows. Namely, the luminosity immediately after switched to the first mode is set to 50% so that the substantial luminance transition may not arise. The luminosity is gradually raised so as to reach to 80% at the start of the next frame period, and is more raised gradually to 100% at the end of the next frame. In this embodiment, the luminosity of the backlight BL is returned to 100% through two-frame period from immediately after being switched from the second mode to the first mode.

In addition, although the luminosity of the display panel 1 is gradually changed by changing the intensity of emitted light from the backlight BL in FIG. 5, the transmissivity of the display panel 1 can be changed gradually, that is, the image signal written in each pixel PX of the display panel 1 is changed gradually, while maintaining the intensity of light from the back light BL.

According to this embodiment using such method, when the first mode and the second mode are switched, the abrupt change of the luminosity is suppressed, and the user's discomfort feeling can be reduced.

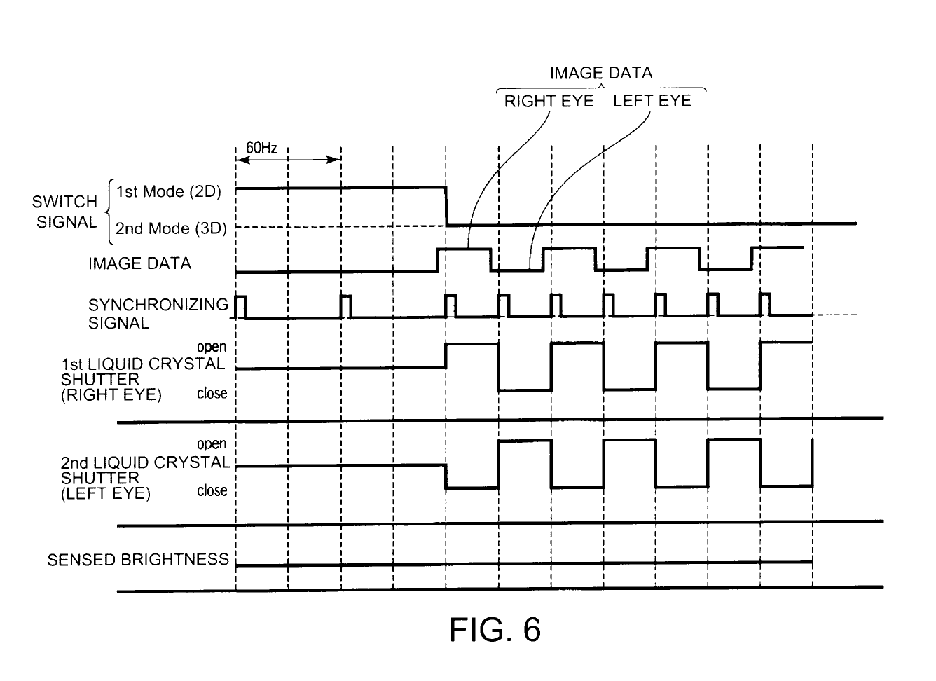

FIG. 6 is a figure for explaining a fourth embodiment for making the change of the luminosity of the display panel 1 between the first mode and the second mode moderate. In the method according to the fourth embodiment, the display system uses the shutter glasses 2 in the second mode as shown in FIG. 1 to observe the three-dimensional picture. In the shutter glasses 2 explained below, the transmissivity of the first liquid crystal shutter 21 and the second liquid crystal shutter 22 is transposed to the transmitted light amount which passes the liquid crystal shutter during per unit time, for example, one frame period.

FIG. 6 shows the switch signal supplied to the control circuit 10, the image data, the synchronizing signal, the driving signal supplied to the first liquid crystal shutter 21 and the second liquid crystal shutter 22 of the shutter glasses 2 from the control circuit 10, and the observed brightness of the display panel 1.

While the first mode is selected, the image signal is written in each pixel PX of the display panel 1 in the frame frequency of 60 Hz based on the first image data supplied to the control circuit 10. At this time, the transmissivity of the first liquid crystal shutter 21 and the second liquid crystal shutter 22 of the shutter glasses 2 is the same.

Namely, in the liquid crystal panels LQP which respectively constitute the first liquid crystal shutter 21 and the second liquid crystal shutter 22, the potential difference between the first electrode EL1 and the second electrode EL2 is the same for the first and second liquid crystal shutters 21 and 22. Furthermore, a third potential difference is formed between the first potential difference (opening state) and the second potential difference (closing state). The transmissivity of the first and second liquid crystal shutters is set to substantially intermediate value between the states where the first potential difference is formed and the second potential difference is formed. If, the transmissivity of the liquid crystal panel LQP is made into 100% in the state where the first potential difference is formed, and is made into 0% in the state where the second potential difference is formed, it is desirable to set the transmissivity of the liquid crystal panel LQP in the state where the third potential difference to approximately 50%.

While the second mode is selected, the picture signals for the right eye and the left eye are written in each pixel PX of the display panel 1 by turns in the frame frequency of 120 Hz based on the second image data supplied to the control circuit 10. At this time, “opening” and “closing” of the first liquid crystal shutter 21 and the second liquid crystal shutter 22 are alternately controlled in the shutter glasses 2 in synchronization with the pictures displayed on the display panel 1.

Namely, in the timing when the picture for the right eye displayed on the display panel 1 is observed, the liquid crystal panel LQP which constitutes the first liquid crystal shutter 21 is in the state where the first potential difference is formed between first electrode EL1 and second electrode EL2. For this reason, in the first shutter 21, the transmissivity of the liquid crystal panel LQP becomes higher than the transmissivity in the case of observing the display panel 1 in the first mode, that is, the transmissivity of the liquid crystal panel LQP is 100%.

On the other hand, in the timing when the picture for the right eye is observed, the liquid crystal panel LQP which constitutes the second liquid crystal shutter 22 is in the state where the second potential difference is formed between first electrode EL1 and second electrode EL2. For this reason, in the second shutter 22, the transmissivity becomes lower than that of the liquid crystal panel LQP in the case of observing the display panel 1 in the first mode, that is, the transmissivity of the liquid crystal panel LQP is 0%.

Then, in the timing when the picture for the left eye displayed on the display panel 1 is observed, the liquid crystal panel LQP which constitutes the first liquid crystal shutter 21 is in the state where the second potential difference is formed between first electrode EL1 and second electrode EL2. For this reason, in the first shutter 21, the transmissivity becomes lower than that of the liquid crystal panel LQP in the case of observing the display panel 1 in the first mode, that is, the transmissivity of the liquid crystal panel LQP is 0%.

On the other hand, in the timing when the picture for the left eye is observed, the liquid crystal panel LQP which constitutes the second liquid crystal shutter 22 is in the state where the first potential difference is formed between first electrode EL1 and second electrode EL2. For this reason, in the second shutter 22, the transmissivity becomes higher than the that of the liquid crystal panel LQP in the case of observing the display panel 1 in the first mode, that is, the transmissivity of the liquid crystal panel LQP is 100%.

In the second mode, the average brightness with respect to time which the user feels becomes substantially the same. Although FIG. 6 illustrates about the operation at the time of switching from the first mode to the second mode, the same method can be applied also when switching from the second mode to the first mode.

According to this embodiment using above method, when the first mode and the second mode are switched, the abrupt change of the luminosity is not sighted by the user, and the user's discomfort feeling can be reduced.

The method shown in FIG. 6 can be applied also when the first mode and the second mode change frequently. Specifically, it is explained by the following fifth embodiment.

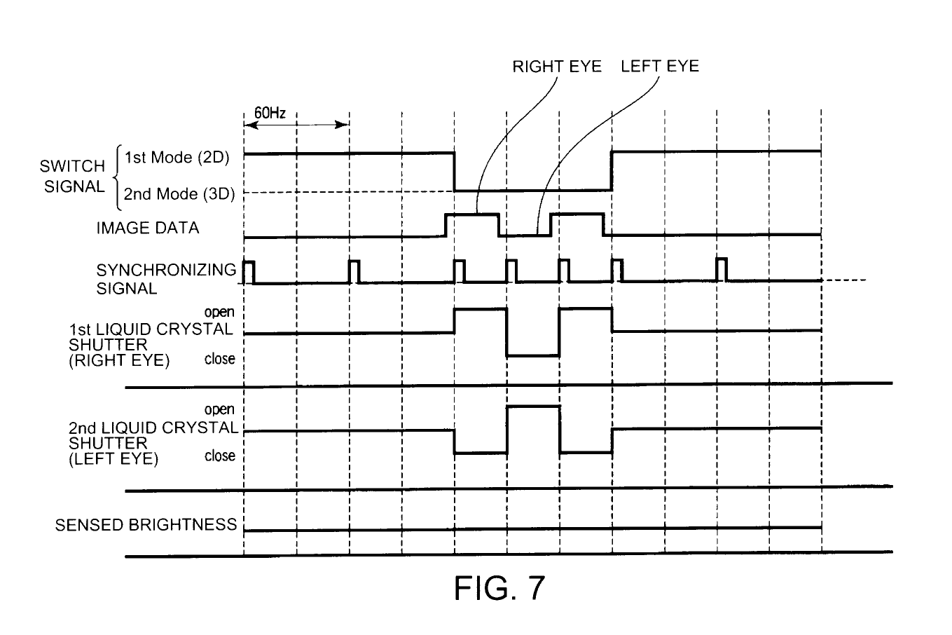

FIG. 7 is a figure for explaining a fifth embodiment for making change of the luminosity of the display panel 1 moderate between the first mode and the second mode.

The method shown in FIG. 7 corresponds to the method in which after the first mode is selected, the second mode is selected for only several frame periods, and then returns to the first mode again,

That is, while the first mode is selected first, the picture signal is written in each pixel PX of the display panel 1 in the frame frequency of 60 Hz based on the first image data supplied to the control circuit 10. At this time, the transmissivity of both the first liquid crystal shutter 21 and the second liquid crystal shutter 22 is about 50% in the shutter glasses 2.

Then, while the second mode is selected, the picture signals for the right eye and the left eye are written in each pixel PX of the display panel 1 by turns in the frame frequency of 120 Hz based on the second image data supplied to the control circuit 10. At this time, in the shutter glasses 2, the transmissivity of the first liquid crystal shutter 21 becomes 100% in synchronization with the picture for the right eye displayed on the display panel 1, while the transmissivity of the second liquid crystal shutter 22 becomes 0%. In contrast, the transmissivity of the first liquid crystal shutter 21 becomes 0%, while the transmissivity of the second liquid crystal shutter 22 becomes 100% in synchronization with the displayed picture for the left eye on the display panel 1.

Again, while the first mode is selected, a picture signal is written in each pixel PX of the display panel 1 in the frame frequency of 60 Hz based on the first image data supplied to the control circuit 10. At this time, the transmissivity of the respective first liquid crystal shutter 21 and the second liquid crystal shutter 22 is about 50% in the shutter glasses 2.

Thus, even if it is a case where the first mode and the second mode are switched frequently, the average brightness with respect to time which the user feels in the first mode and the second mode becomes almost the same by controlling the operation of the shutter glasses 2 so as to follow the frequent switching operation.

According to this embodiment using above method, when the first mode and the second mode are switched, the abrupt change of luminosity is not sighted by the user, and the discomfort feeling can be reduced.

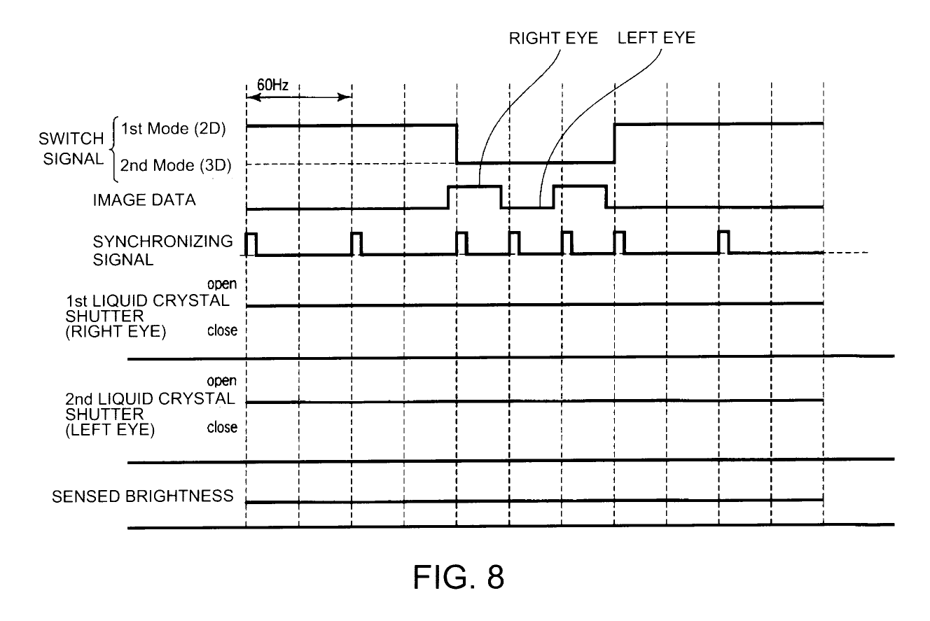

FIG. 8 is a figure for explaining a sixth embodiment for making the change of the luminosity of the display panel 1 moderate between the first mode and the second mode.

The method shown in FIG. 8 is related to the method shown in FIG. 7 in which the second mode is selected during only several frame periods after the first mode is selected and returns to the first mode again. The method shown in FIG. 8 is different from that shown in FIG. 7 in the point that the transmissivity of the shutter glasses 2 of the previously selected mode is maintained over two or more frame periods.

That is, while the first mode is selected first, the picture signal is written in each pixel PX of the display panel 1 in the frame frequency of 60 Hz based on the first image data supplied to the control circuit 10. At this time, the transmissivity of both the first liquid crystal shutter 21 and the second liquid crystal shutter 22 is about 50% in the shutter glasses 2, respectively.

Then, the control circuit 10 which receives the switch signal to switch from the first mode to the second mode holds the driving signal supplied to the shutter glasses 2 irrespective of the supplied image data during over two or more frame periods, for example, three frame periods. For this reason, although the picture signals for the right eye and the left eye are written in each pixel PX of the display panel 1 by turns in the frame frequency of 120 Hz based on the second image data supplied to the control circuit 10, the transmissivity of the first liquid crystal shutter 21 and the second liquid crystal shutter 22 in the shutter glasses 2 is maintained to the same value of about 50% as the first mode, without synchronizing with the pictures for the right eye and the left eye which are displayed on the display panel 1 at this time.

While the first mode is selected again, the picture signal is written in each pixel PX of the display panel 1 based on the first image data supplied to the control circuit 10 in the frame frequency of 60 Hz. At this time, the transmissivity of the first liquid crystal shutter 21 and the second liquid crystal shutter 22 in the shutter glasses 2 is respectively about 50%.

Thus, even if it is a case where the first mode and the second mode are switched frequently, it becomes possible to reduce the user's discomfort feeling resulting from the frequent mode switching by holding the operation of the shutter glasses 2 for predetermined period without following in the frequent switching operation.

When the selected mode continues after maintaining the transmissivity of the shutter glasses 2 over a predetermined plurality of frame periods, the transmissivity of the shutter glasses 2 is controlled according to the selected mode.

In this embodiment, although the liquid crystal display panel is used as the display panel 1, it is possible to use other displays such as an organic electroluminescence display panel and a plasma display panel, etc.

Moreover, if the brightness of the display panel 1 is set so that the brightness is different between the time of displaying a picture in the first mode and the time of displaying the picture in the second mode, it is desirable to adjust the transmissivity of the shutter glasses 2 so that the abrupt luminance change may not be felt by the user wearing the shutter glasses 2.

Moreover, the method of controlling the transmissivity of the shutter glasses 2 is not restricted to the above mentioned methods. However, when the transmissivity is controlled by changing transmissivity with time, the low frequency wave which can be recognized by user's eyes is not suitable. Instead, a high frequency wave, for example, the wave of 1 kHz or more is desirable.

While certain embodiments have been described, these embodiments have been presented by way of example only, and are not intended to limit the scope of the inventions. In practice, the structural and method elements can be modified without departing from the spirit of the invention. Various embodiments can be made by properly combining the structural and method elements disclosed in the embodiments. For example, some structural and method elements may be omitted from all the structural and method elements disclosed in the embodiments. Furthermore, the structural and method elements in different embodiments may properly be combined. The accompanying claims and their equivalents are intended to cover such forms or modifications as would fall with the scope and spirit of the inventions.

What is claimed is:

1. A display device, comprising:
a display panel including pixels, a first image signal for displaying two-dimensional pictures, a second image signal for displaying three-dimensional pictures, and a third image signal for displaying a black picture being written into the pixels; and
a control circuit to write the third image signal to the pixels of the display panel during at least one frame period when switching a first mode for displaying the two-dimensional pictures and a second mode for displaying the three-dimensional pictures.

2. The display device according to claim 1, wherein while the first mode is selected, the first image signal is written in each pixel of the display panel in a first frame frequency, and while the second mode is selected, the second image signal is written in each pixel of the display panel in a second frame frequency that is higher than the first frame frequency.

3. The display device according to claim 1, wherein the second image signal includes a first picture signal for right eye and a second picture signal for left eye, and the first and second picture signals are written in each pixel of the display panel by turns.

4. The display device according to claim 2, wherein the first frame frequency is 60 Hz, and the second frame frequency is 120 Hz

5. A display device, comprising:
a transmissive type display panel including pixels, a first image signal for displaying two-dimensional pictures and a second image signal for displaying three-dimensional pictures being written into the pixels;
a back light to illuminate the display panel; and
a control circuit to switch off the back light during at least one frame period when switching a first mode for displaying the two-dimensional pictures and a second mode for displaying the three-dimensional pictures.

6. The display device according to claim 5, wherein the backlight is switches off irrespective of the image signals written into the pixels.

7. The display device according to claim 5, wherein while the first mode is selected, the first image signal is written in each pixel of the display panel in a first frame frequency, and while the second mode is selected, the second image signal is written in each pixel of the display panel in a second frame frequency that is higher than the first frame frequency.

8. The display device according to claim 5, wherein the second image signal includes a first picture signal for right eye and a second picture signal for left eye, and the first and second picture signals are written in each pixel of the display panel by turns.

9. The display device according to claim 7, wherein the first frame frequency is 60 Hz, and the second frame is 120 Hz.

10. A display device, comprising:
a display panel including pixels, a first image signal for displaying two-dimensional pictures and a second image signal for displaying three-dimensional picture, and
a control circuit to change gradually the luminance of the display panel over two or more frame period when switching a first mode for displaying the two-dimensional pictures and a second mode for displaying the three-dimensional picture.

11. The display device according to claim 10, further comprising a backlight to illuminate the display panel, wherein
while the first mode is selected, the two-dimensional picture signal is written in each pixel of the display panel in a first frame frequency, and while the second mode is selected, the three-dimensional picture signal is written in each pixel of the display panel in a second frame frequency that is higher than the first frame frequency,
the three-dimensional picture signal includes a first picture signal for right eye and a second picture signal for left eye, and the first and second picture signals are written in each pixel of the display panel by turns, and
intensity of emitted light from the backlight is controlled so as to gradually change the luminance of the display panel when switching the first mode for displaying the two dimensional pictures and the second mode for displaying the three dimensional pictures.

12. The display device according to claim 11, the intensity of the emitted light from the back light is changed so that the intensity of the emitted light is dropped once and then gradually raised up when the display panel is switched from the second mode to the first mode.

13. A pair of liquid crystal shutter glasses, comprising:
a first liquid crystal shutter arranged at a right eye side;
a second liquid crystal shutter arranged at a left eye side; and
a control circuit to control the transmissivity of the first and second liquid crystal shutters; wherein
in a first mode for displaying two-dimensional pictures, the transmissivity of the first liquid crystal shutter and the second liquid crystal shutter are controlled to a first transmissivity;
in a second mode for displaying three-dimensional pictures, when a picture for the right eye is observed, the first liquid crystal shutter is controlled to a second transmissivity higher than the first transmissivity, and the second liquid crystal shutter is closed; and
in the second mode for displaying the three-dimensional pictures, when a picture for the left eye is observed, the second liquid crystal shutter is controlled to a second transmissivity higher than the first transmissivity, and the first liquid crystal shutter is closed.

14. A pair of liquid crystal shutter glasses according to claim 13, the first transmissivity is substantially intermediate value of the second transmissivity.

15. A pair of liquid crystal shutter glasses according to claim 13, wherein the control circuit sets the transmissivity of the first liquid crystal shutter and the second liquid crystal shutter to the first transmissivity during two or more frame periods when the first mode and the second mode are switched.

16. A pair of liquid crystal shutter glasses according to claim 15, wherein in case the selected mode continues during a predetermined frame periods after maintaining the transmissivity of the shutter glasses at the first transmissivity, the transmissivity of the shutter glasses is controlled according to the selected mode.

17. A pair of liquid crystal shutter glasses according to claim 13, further comprising a liquid crystal panel formed of a liquid crystal layer held between a pair of electrodes, wherein the liquid crystal layer is formed of an OCB (Optically Compensated Bend) type liquid crystal layer.

18. A display system, comprising:
a display panel including pixels, a first image signal for displaying two-dimensional pictures and a second image signal for displaying three-dimensional pictures for right eye and left eye being written into the pixels;
a pair of liquid crystal shutter glasses including a first liquid crystal shutter arranged at the right eye side and a second liquid crystal shutter arranged at the left eye side; and
a control circuit to control the transmissivity of the first and second liquid crystal shutters; wherein
in a first mode for displaying the two-dimensional pictures, the transmissivity of the first liquid crystal shutter and the second liquid crystal shutter is controlled to the a transmissivity while the first image signal is written in the pixels;
in a second mode for displaying the three-dimensional pictures, when a picture for the right eye is observed, the first liquid crystal shutter is controlled to a second transmissivity higher than the first transmissivity, and the second liquid crystal shutter is closed in synchronization of writing of the picture signal for the right eye to the pixel; and when a picture for the left eye is observed, the second liquid crystal shutter is controlled to a second transmissivity, and the first liquid crystal shutter is closed in synchronization of writing of the picture signal for the left eye to the pixel while the second image signal is written in the pixels.

19. The display system according to claim 18, wherein while the first mode is selected, the two-dimensional picture signal is written in each pixel of the display panel in a first frame frequency, and while the second mode is selected, the three-dimensional picture signal is written in each pixel of the display panel in a second frame frequency that is higher than the first frame frequency.

20. The display system according to claim 18, the first transmissivity of the first and second liquid crystal shutters is substantially intermediate value of the second transmissivity.

21. The display system according to claim 18, wherein a pair of shutter glasses further comprises a liquid crystal panel formed of a liquid crystal layer held between a pair of electrodes, and the liquid crystal layer is formed of an OCB (Optically Compensated Bend) type liquid crystal layer.

22. The display system according to claim 18, wherein the control circuit sets the transmissivity of the first liquid crystal shutter and the second liquid crystal shutter to the first transmissivity during two or more frame periods when switching the first mode and the second mode.

23. The display system according to claim 22, wherein in case the selected mode continues during a predetermined frame periods after maintaining the transmissivity of the shutter glasses at the first transmissivity, the transmissivity of the shutter glasses is controlled according to the selected mode.
